(19) United States
(12) Patent Application Publication
(10) Pub. No.: US 2009/0073155 A1
(43) Pub. Date: Mar. 19, 2009

(54) Image Display Device

(76) Inventors: Hajime Akimoto, Kokubunji (JP); Kaoru Yanagawa, Ichinomiya (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/212,701

(22) Filed: Sep. 18, 2008

(30) Foreign Application Priority Data
Sep. 19, 2007 (JP) 2007-242445

(51) Int. Cl. G06F 3/038

(52) U.S. Cl. 345/211

(57) ABSTRACT

The present invention provides an image display device which can realize the stabilization of system electric power, and can suppress crosstalk attributed to voltage drop of power source line by preventing the irregularities in power consumption which occur with time. The image display device includes a plurality of pixels each of which includes a current-drive-type light emitting element, a plurality of signal lines which writes an image voltage in the respective pixels; and a write pixel selection means which selects the pixels in which the image voltage is written via the plurality of signal lines among the plurality of pixels with respect to every display line, and the image display device includes a power source line which supplies electricity to the light emitting elements in the respective pixels arranged on each display line, and a power source circuit which supplies a voltage having a ramp waveform whose voltage level is changed with time with respect to the power source line during a light emission period. The power source line is provided for every display line, and a phase of the voltage having the ramp waveform differs for every power source line.

### CLAIM OF PRIORITY

The present application claims priority from Japanese Application JP 2007-242445 filed on Sep. 19, 2007, the content of which is hereby incorporated by reference into this application.

### BACKGROUND OF THE INVENTION

1. Field of the Invention

The present invention relates to an image display device, and more particularly to a drive method of an active-matrix-type organic electroluminescence display.

2. Description of the Related Art

An active-matrix-drive-type organic electroluminescence display (hereinafter, referred to as AMOLED) is expected as a flat panel display of next generation which succeeds a conventional liquid crystal display.

Conventionally, as a drive circuit of the AMOLED, as disclosed in JP-A-2004-341144 (Patent Document 1), there has been known a circuit having the two transistor constitution made of a thin film transistor for driving which supplies an electric current to an organic electroluminescence element (hereinafter, referred to as EL drive TFT), a holding capacitor which is connected to a gate electrode of the EL drive TFT and holds an image voltage, and a thin film transistor for resetting which is connected between the gate electrode and a drain electrode of the EL drive TFT (hereinafter, referred to as reset switch).

The AMOLED disclosed in the above-mentioned patent document 1 has an advantage that the AMOLED can obtain OLED light emission corresponding to a signal voltage of Vs while canceling irregularities of a threshold voltage Vth of the drive TFT provided for every pixel as irregularities of logic threshold value of an inverter circuit constituted of the drive TFT and the organic EL element and, at the same time, this cancellation of the irregularities of the threshold voltage Vth can be realized using two transistors in total consisting of the drive TFT and the reset switch and the capacitance of one holding capacitor provided for every pixel.

### SUMMARY OF THE INVENTION

In the AMOLED disclosed in the above-mentioned patent document 1, a triangular-wave voltage is inputted to signal lines during a light emission period thus acquiring light emission corresponding to the signal voltage of Vs.

However, in the AMOLED disclosed in the above-mentioned patent document 1, when the triangular-wave voltage is inputted to the signal lines during the light emission period, all pixels in a panel emit light in synchronized manner and hence, there arises irregularities in power consumption with time thus giving rise to a drawback that the AMOLED is disadvantageous with respect to the stabilization of system electric power or the suppression of crosstalk attributed to voltage drop of a power source line.

The present invention has been made to overcome the above-mentioned drawbacks of the related art, and it is an object of the present invention to provide a technique which, in an image display device, can stabilize the system electric power and can suppress crosstalk attributed to voltage drop of a power source line by preventing irregularities in power consumption with time.

The above-mentioned and other objects and novel features of the present invention will become apparent from the description of this specification and attached drawings.

To briefly explain typical invention among inventions disclosed in this application, they are as follows.

(1) The present invention is directed to an image display device including a plurality of pixels each of which includes a current-drive-type light emitting element, a plurality of signal lines which writes an image voltage in the respective pixels, and a write pixel selection means which selects the pixels in which the image voltage is written via the plurality of signal lines among the plurality of pixels with respect to every display line, wherein the image display device includes a power source line which supplies electricity to the light emitting elements in the respective pixels arranged on each display line, and a power source circuit which supplies a voltage having a ramp waveform whose voltage level is changed with time with respect to the power source line during a light emission period.

(2) In the display device having the constitution (1), the power source line is provided for every display line, and a phase of the voltage having the ramp waveform differs for every power source line.

(3) In the display device having the constitution (1), the power source line is provided for every display line and the power source line is formed of a plurality of power source lines which is divided into a plurality of groups, and a phase of the voltage having the ramp waveform differs for the power source lines of every group.

(4) In the display device having one of the constitutions (1) to (3), the voltage having the ramp waveform is a voltage which is changed at least one time from a first voltage level to a second voltage level having a potential higher than the first voltage level or from the second voltage level to the first voltage level during the light emitting period.

(5) In the display device having one of the constitutions (1) to (4), the voltage having the ramp waveform is a voltage whose voltage level is linearly changed with time.

(6) In the display device having the constitution (5), the voltage having the ramp waveform is a triangular-wave voltage or a sawtooth-wave voltage.

(7) In the display device having one of the constitutions (1) to (4), the voltage having the ramp waveform is a voltage whose voltage level is non-linearly changed with time.

(8) In the display device having one of the constitutions (1) to (7), the write pixel selection means includes a plurality of scanning lines, each pixel includes a drive transistor which has a first electrode thereof connected to the power source line and a second electrode thereof connected to one end of the light emitting element, a switching transistor which is connected between a gate electrode and the second electrode of the drive transistor, and a capacitive element which is connected between the gate electrode of the drive transistor and the corresponding signal line out of the plurality of signal lines, and another end of the light emitting element of each pixel is connected to a ground contact potential, and a gate electrode of the switching transistor is connected to the corresponding scanning line out of the plurality of scanning lines.

(9) In the display device having the constitution (8), the drive transistor and the switching transistor are formed of a p-type transistor.

(10) In the display device having the constitution (8) or (9), the drive transistor and the switching transistor respectively have a semiconductor layer which is made of amorphous silicon.

(11) In the display device having the constitution (8) or (9), the drive transistor and the switching transistor respectively have a semiconductor layer which is made of polysilicon.

(12) In the display device having one the constitutions (8) to (11), the switching transistor is configured to be turned on in a first period in which a reset voltage is supplied to the corresponding scanning line out of the plurality of scanning lines and to be turned off in other period during a writing period before the light emission period, the image voltage is inputted to the pixel in which the switching transistor is turned off in the first period from the plurality of signal lines in the first period and in the second period which succeeds the first period during the writing period, and a voltage having a high potential is inputted to the pixel in which the switching transistor is turned off in the first period from the power source lines in the first period and in the second period.

(13) In the display device having one of the constitutions (1) to (12), the light emitting element is an organic light emitting diode element.

To briefly explain advantageous effects obtained by typical invention among inventions disclosed in this application, they are as follows.

The image display device of the present invention can realize the stabilization of system electric power, and can suppress crosstalk attributed to voltage drop of the power source line by preventing the irregularities in power consumption which occur with time.

### BRIEF DESCRIPTION OF THE DRAWINGS

FIG. 1 is a block diagram showing the schematic constitution of an organic EL display panel of an image display device according to an embodiment of the present invention;

FIG. 2 is a circuit diagram for explaining the structure of a pixel shown in FIG. 1;

FIG. 3 is a timing chart for explaining the manner of operation of the organic EL display panel according to the embodiment of the present invention;

FIG. 4 is a timing chart for explaining the manner of operation of the pixels on a kth row in the organic EL display panel according to the embodiment of the present invention;

FIG. 5 is a view for explaining a voltage having a ramp waveform which is applied to power source lines during a “light emission period” in the organic EL display panel according to the embodiment of the present invention; and

FIG. 6 is an operation timing chart of a conventional organic EL display panel.

### DESCRIPTION OF THE PREFERRED EMBODIMENTS

Hereinafter, an embodiment of the present invention is explained in detail in conjunction with drawings.

Here, in all drawings for explaining the embodiment, parts having identical functions are given same numerals and their repeated explanation is omitted.

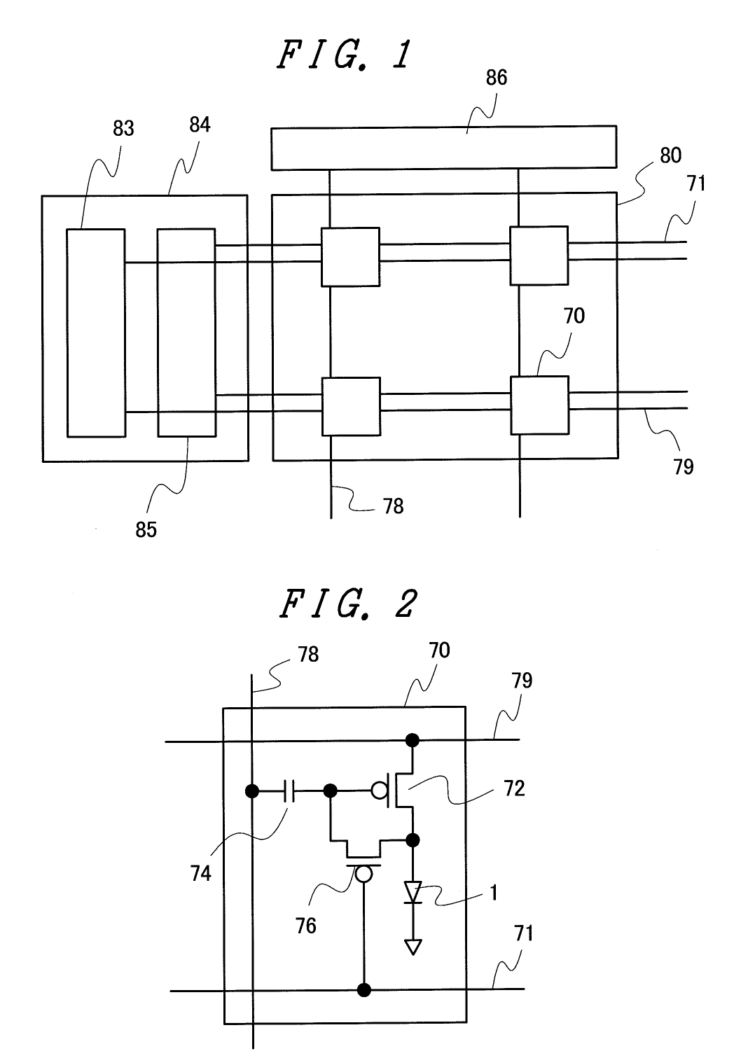

FIG. 1 is a block diagram showing the schematic constitution of an organic EL display panel of an image display device of the embodiment of the present invention.

As shown in FIG. 1, a plurality of pixels 70 is arranged within a display region 80 of the organic EL display panel in a matrix array. Here, to each pixel 70, a signal line 78, a reset gate line (a scanning line of the present invention) 71, and a power source line 79 are respectively connected.

One end of the signal line 78 is connected to a signal voltage generation circuit 86, one end of the reset gate line 71 is connected to a scanning circuit 85, and the power source line 79 is connected to a power source circuit 83.

Here, although a large number of pixels 70 are arranged within the display region 80 of the organic EL display panel in an actual image display device, for the sake of brevity, in FIG. 1, only 4 pixels are illustrated. Further, although a common ground line is connected to the pixel 70 besides the above-mentioned lines as described later, the common ground line is omitted from the drawing.

Further, the signal voltage generation circuit 86 is formed of a DA converter and a voltage buffer circuit using a conventionally well-known LSI technique, and the scanning circuit 85 and the power source circuit 83 are also formed of a single Si semiconductor chip 84 which is manufactured using a known LSI technique.

FIG. 2 is a circuit diagram for explaining the structure of the pixel 70 shown in FIG. 1.

As shown in FIG. 2, in each pixel 70, an organic electroluminescence element (hereinafter, referred to as an organic EL element) 1 which constitutes a light emitting element is arranged, and a cathode electrode of the organic EL element is connected to the common ground line. Further, an anode electrode of the organic EL element 1 is connected to the power source line 79 via a thin film transistor (hereinafter, referred to as a drive TFT) 72.

Further, a gate electrode of the drive TFT 72 is connected to the signal line 78 via a holding capacitor (a capacitative element of the present invention) 74, and a reset-use thin film transistor (hereinafter, referred to as a reset switch) 76 is arranged between a drain electrode and the gate electrode of the drive TFT 72. Here, a gate electrode of the reset switch 76 is connected to the reset gate line 71.

The drive TFT 72 and the reset switch 76 are constituted of an amorphous silicon thin film transistor which uses amorphous silicon as a material of a semiconductor layer thereof or a polysilicon thin film transistor which uses polysilicon as a material of a semiconductor layer thereof. The drive TFT2 and the reset switch 76 are formed on a glass substrate. Since there is no large difference between a manufacturing method or the like of the amorphous silicon thin film transistor, the polysilicon thin film transistor and the organic EL element adopted by this embodiment and a manufacturing method or the like of the above-mentioned components which has been adopted conventionally, the explanation of the manufacturing method or the like is omitted in this embodiment.

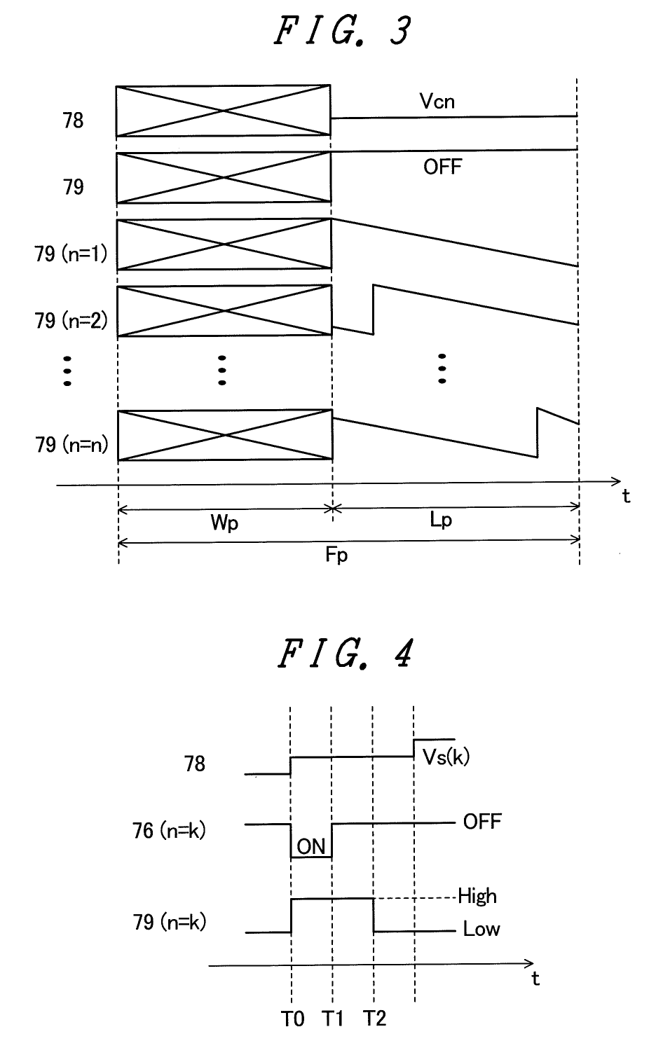

The manner of operation of the organic EL display panel of this embodiment is explained in conjunction with FIG. 3 and FIG. 4.

FIG. 3 is a timing chart for explaining the manner of operation of the organic EL display panel of this embodiment. That is, the timing chart shows respective operations of the signal line 78, the reset switch 76 and the power source line 79 during 1 frame period Fp. Here, with respect to the power source line 79, a first row is described as n=1, a second row is described as n=2, . . . , an nth row is described as n=n.

Here, an upper level of a drive timing waveform of the reset switch 76 indicates that the reset switch 76 assumes an OFF state and a lower level of the drive timing waveform of the reset switch 76 indicates that the reset switch 76 assumes an ON state.

1 frame period Fp is constituted of a former-half “writing period Wp” and a latter-half “light emission period Lp”, and lengths of both periods are set substantially equal to each other.

In the former-half “writing period Wp”, the reset switch 76 arranged in the pixel 70 and the power source line 79 are sequentially driven in accordance with scanning by the scanning circuit 85 and the power source circuit 83, and a predetermined image voltage is inputted to the signal line 78 in synchronism with the above-mentioned driving.

Here, the operation of the pixels 70 on the kth row which are selected by the scanning circuit 85 and the power source circuit 83 during the “writing period Wp” is explained in conjunction with FIG. 4.

FIG. 4 is a timing chart for explaining the operation of pixels 70 on the kth row in the organic EL display panel of this embodiment. FIG. 4 shows the operations of the signal line 78, the reset switch 76 and the power source line 79 when a row of pixels 70 is selected by the scanning circuit 85 and the power source circuit 83 and an image voltage is written in the pixels.

Here, an upper level of the drive timing waveform of the reset switch 76 indicates that the reset switch 76 assumes an OFF state and a lower level of the drive timing waveform of the reset switch 76 indicates that the reset switch 76 assumes an ON state. Further, a state that a voltage of the power source line 79 is at an upper level is indicated by an H level (high voltage) and a state that the voltage of the source line 79 is at a low level is indicated by L level (low voltage). Here, the L-level voltage is a common ground voltage.

In writing the display image voltage in the pixels 70, first of all, the reset switch 76 is turned on at a point of time TO so that the H-level voltage is supplied to the power source line 79 and the image voltage Vs (k) is supplied to the signal line 78. Accordingly, the drive TFT 72 assumes the diode connection in which the gate electrode and the drain electrode thereof are connected with each other, and a voltage of the gate electrode of the drive TFT 72 which is stored in the holding capacitor 74 in a preceding field is cleared.

Here, the pixel circuit of this embodiment may be interpreted as an inverter circuit which adopts the drive TFT 72 as a drive transistor and the organic EL element 1 as a load. In this interpretation, the circuit connection after a point of time TO can be assumed as a state in which an input terminal and an output terminal of the inverter circuit are short-circuited by the reset switch 76. Accordingly, at both of an input terminal and an output terminal of the inverter circuit, a substantially intermediate voltage between a “high voltage output” and a “low voltage output” in an inverter circuit output is generated.

Next, when the reset switch 76 is turned off at a point of time T1, the gate electrode voltage of the drive TFT 72 is fixed to a substantially intermediate voltage between the “high voltage output” and the “low voltage output” in the above-mentioned inverter circuit output. Here, the “high voltage output” implies a power source voltage of H level which is applied to the power source line 79 and the “low voltage output” implies a voltage of L level which is a common ground voltage.

That is, when the preceding image voltage Vs (k) is supplied to the signal line 78 due to the writing of the image voltage in the holding capacitor 74, the substantially intermediate voltage between the “high voltage output” and the “low voltage output” in the above-described inverter circuit output is reproduced at the gate electrode of the drive TFT 72.

Thereafter, the power source line voltage assumes the L level at a point of time T2, and the writing of the image voltage with respect to this row (n=k) is completed.

Sequentially, writing of a display signal to the pixels 70 on next row (n=k+1) is started, and an image voltage Vs (k+1) to be written in the next pixels 70 (not shown in the drawing) is supplied to the signal line 78.

When the image voltage is written in all pixels 70 by repeating the above-mentioned operation, the former-half “writing period” is finished.

Next, the manner of operation of the organic EL display panel during the latter-half “light emission period” is explained also in conjunction with FIG. 3.

In the latter-half “light emission period”, a fixed voltage (Vcn) shown in FIG. 3 is applied to the signal lines 78 and the reset switches 76 in all pixels 70 are turned off simultaneously. Further, to the respective power source lines 79, sawtooth voltages whose phases are gradually shifted from each other as shown in the drawing are applied.

For example, assuming a voltage of the power source line 79 when the image voltage of Vs is written in the power source line 79 as Vss and assuming the sawtooth voltages applied to the respective power source lines 79 as Vva, when the relative voltage relationship between the sawtooth voltage (Vva) supplied to the power source line 79 and the fixed voltage (Vcn) supplied to the signal line 78 is set to satisfy a following formula (1),

|Vva−Vcn|=|Vvs−Vs| (1)

an output of the inverter circuit which adopts the drive TFT 72 as the drive transistor and adopts the organic EL element 1 as the load assumes the substantially intermediate voltage.

Further, when the above-mentioned relative voltage relationship is set to satisfy a following formula (2),

|Vva−Vcn|<|Vvs−Vs| (2)

the output of the inverter circuit which adopts the drive TFT 72 as the drive transistor and adopts the organic EL element 1 as the load assumes the “low voltage output” (common ground voltage).

Still further, when the above-mentioned relative voltage relationship is set to satisfy a following formula (3),

|Vva−Vcn|>|Vvs-Vs| (3)

the output of the inverter circuit which adopts the drive TFT 72 as the drive transistor and adopts the organic EL element 1 as the load assumes the “high voltage output”.

Accordingly, when the relative voltage relationship between the voltage supplied to the power source voltage 79 and the fixed voltage (Vcn) supplied to the signal line 78 satisfies the above-mentioned formula (3), the organic EL elements 1 of the pixels 70 emit light. Here, the organic EL element 1 substantially takes a binary state consisting of a light-emission state and a non-light-emission state and hence, by controlling a light emission period of the organic EL element 1 based on the image voltage Vs, it is possible to realize the gray-scale light emission.

Further, in this embodiment, the phase of the sawtooth voltage supplied to the power source lines 79 is shifted for every row (display line) and hence, the above-mentioned operation is executed at a point of time that the phase is shifted for every row. Further, the light emission timing is modulated based on a magnitude of the image voltage written in the holding capacitor 74 and hence, the organic EL element 1 performs the modulated gray-scale light emission based on the image voltage during the light emission period at timing shifted for every row.

In this embodiment, a plurality of power source lines 79 may be provided for every plurality of display lines, and the phase of the sawtooth voltage supplied to the power source lines 79 may be changed for every plurality of power source lines 79 which is provided for every plurality of display lines.

Hereinafter, a conventional organic EL display panel is explained for comparison with this embodiment.

A circuit diagram which shows the structure of a pixel of the conventional organic EL display panel is equal to the circuit diagram shown in FIG. 2.

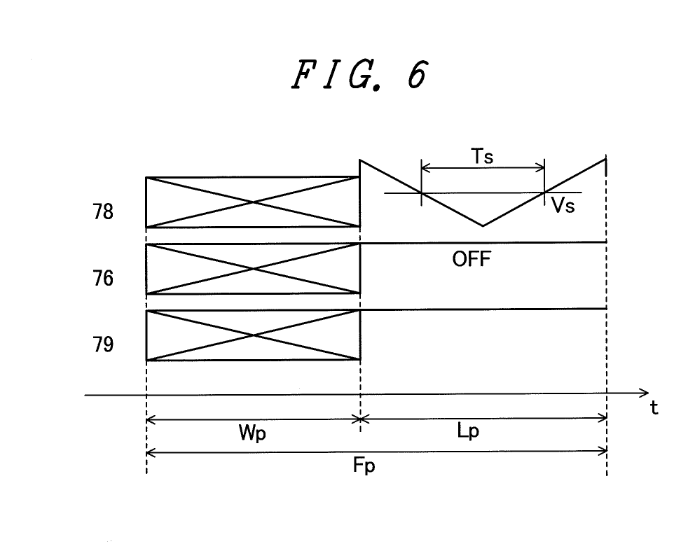

FIG. 6 is an operation timing chart of the conventional organic EL display panel, wherein the respective operations of a signal line 78, a reset switch 76, a power source line during 1 frame period Fp are shown.

The operations of these components during a former-half “writing period Wp” in 1 frame period Fp are equal to the operations of the corresponding components of this embodiment and hence, the detailed explanation of the operations is omitted.

In a latter-half “light emission period Lp”, as shown in FIG. 6, a triangular-wave voltage having a waveform in which a voltage level becomes minimum at the center thereof is applied to the signal line 78 and, simultaneously, the reset switches of all pixels 70 are turned off and an H-level voltage is applied to the power source line 79.

When a voltage equal to the image voltage Vs written in the holding capacitor 74 is supplied to the signal line 78, the output of the inverter circuit which adopts the drive TFT 72 as the drive transistor and adopts the organic EL element 1 as the load assumes the substantially intermediate voltage. When a voltage whose level is higher than the image voltage Vs is supplied to the signal line 78, the output of the inverter circuit assumes the “low voltage output” (common ground voltage) Further, when a voltage whose level is lower than the image voltage Vs is supplied to the signal line 78, the output of the inverter circuit assumes the “high voltage output” (H-level voltage applied to the power source line 79).

Accordingly, as shown in FIG. 6, during a period Ts in which the voltage of the signal line 78 becomes lower than the image voltage Vs preliminarily written in the pixel 70, the “high voltage output” is applied to the organic EL element 1 of the pixel 70 so that the organic EL element 1 emits light. That is, the organic EL element 1 substantially takes a binary state consisting of the light-emission state and the non-light-emission state during the light emission period Lp, and by controlling an actual light emission period Ts based on the image voltage Vs, the organic EL element 1 can perform the gray-scale light emission.

In this embodiment, with respect to a point that it is possible to acquire the OLED light emission corresponding to the image voltage Vs while canceling irregularities of a threshold voltage Vth of the drive TFT 72 present for every pixel as irregularities of a logic threshold-value of the inverter circuit constituted of the drive TFT 72 and the organic EL element 1, the organic EL display panel of this embodiment can acquire the substantially same advantageous effects as the above-described conventional organic EL display panel.

However, in the conventional organic EL display panel, when a voltage having a triangular waveform is inputted to the signal line 78 during the light emission period, all pixels in the panel emit light in synchronized manner and hence, there arises irregularities in power consumption with time thus giving rise to a drawback with respect to the stabilization of the system electric power or the suppression of cross talk at tributed to voltage drop of the power source line.

To the contrary, in this embodiment, during the light emission period, the fixed voltage (Vcn) is supplied to the signal lines 78 in place of the triangular-wave voltage, the sawtooth-wave voltage is supplied to the power source lines 79. Further, the power source lines 79 are arranged in the extending direction of the reset gate lines 71, and the phase of the sawtooth-wave voltage applied to the power source lines 79 is shifted for every power source 79 and hence, it is possible to shift the light emission timing of the organic EL element 1 for every display line thus realizing the stabilization of the system electric power and the suppression of crosstalk attributed to the voltage drop of the power source line.

Further, in this embodiment, even when a low-cost and low-performance TFT is used, by shifting the light emission timing for every pixel, it is possible to realize the stabilization of the system electric power and the suppression of crosstalk attributed to the voltage drop of the power source line.

Here, this embodiment has an advantage that the cancellation of irregularities of the threshold voltage Vth can be realized using two transistors in total consisting of the drive TFT 72 and the reset switch 76 and the capacitance of one holding capacitor 74 provided for every pixel. Accordingly, the number of constitutional elements per one pixel can be reduced and, as a result, it is possible to enhance a yield rate of light emitting display devices thus realizing the reduction of cost.

In addition to such an advantage, this embodiment can acquire an excellent advantage that irregularities of a current drive ability or the like of the drive TFT 72 can be also canceled. This is because that the organic EL element 1 is substantially driven in a binary state consisting of the light-emission state and the non-light-emission state.

Here, in this embodiment, the larger a width of the gate electrode of the drive TFT 72, the steeper the rise of the inverter characteristic of the pixel circuit becomes and hence, the ability of reducing irregularities of the logical threshold value of the inverter circuit is enhanced. Here, it must be noted that when a width of the gate electrode of the drive TFT 72 is increased, it is also necessary to increase the capacitance of the holding capacitor 74 corresponding to the increase of the width of the gate electrode.

In the present invention, the voltage applied to the power source lines 79 during “light emission period” is not limited to the sawtooth-wave voltage. That is, the voltage applied to the power source lines 79 during the “light emission period” may be a voltage having a ramp waveform whose voltage level is changed with time.

With respect to the ramp waveform, any waveform may be used provided that the voltage is changed at least one time from a first voltage level of VDL to a second voltage level of VDH having a potential higher than the first voltage level of VDL or from the second voltage level of VDH to the first voltage level of VDL.

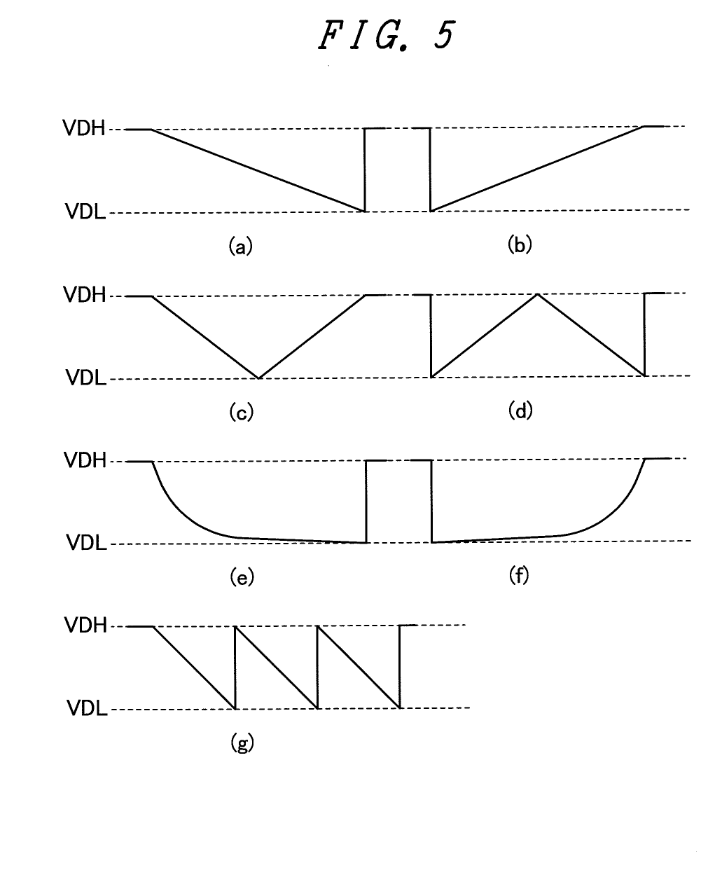

For example, the voltage having a ramp waveform which is applied to the power source lines 79 during “light emission period” maybe a sawtooth-wave voltage which is linearly changed from the second voltage level of VDH to the first voltage level of VDL as shown in FIG. 5(a), or may be a sawtooth-wave voltage which is linearly changed from the first voltage level of VDL to the second voltage level of VDH as shown in FIG. 5(b).

Further, the voltage applied to the power source lines 79 may be a triangular-wave voltage which is linearly changed to the second voltage level of VDH after being linearly changed from the second voltage level of VDH to the first voltage level of VDL as shown in FIG. 5(c), or maybe a triangular-wave voltage which is linearly changed to the first voltage level of VDL after being linearly changed from the first voltage level of VDH to the second voltage level of VDL as shown in FIG. 5(d)

Further, the voltage having a ramp waveform which is applied to the power source lines 79 during “light emission period” may be a voltage which is non-linearly changed with time as shown in FIG. 5(e) and FIG. 5(f). By adopting the voltage having the ramp waveform which is non-linearly changed with time as shown in FIG. 5(e) and FIG. 5(f), it is possible to impart a proper gamma characteristic to a display image.

Further, as shown in FIG. 5(g), the voltage having a ramp waveform which is applied to the power source lines 79 during “light emission period” may be a voltage which is changed two times or more from the first voltage level of VDL to the second voltage level of VDH having a potential higher than the first voltage level of VDL or from the second voltage level of VDH to the first voltage level of VDL.

Although the invention made by the inventors of the present invention has been specifically explained in conjunction with the above-mentioned embodiment heretofore, it is needless to say that the present invention is not limited to the above-mentioned embodiment and various modifications are conceivable without departing from the gist of the present invention.

What is claimed is:

1. An image display device comprising:
a plurality of pixels each of which includes a current-drive-type light emitting element;
a plurality of signal lines which writes an image voltage in the respective pixels; and
a write pixel selection means which selects the pixels in which the image voltage is written via the plurality of signal lines among the plurality of pixels with respect to every display line, wherein
the image display device includes a power source line which supplies electricity to the light emitting elements in the respective pixels arranged on each display line, and
a power source circuit which supplies a voltage having a ramp waveform whose voltage level is changed with time with respect to the power source line during a light emission period.

2. An image display device according to claim 1, wherein the power source line is provided for every display line, and a phase of the voltage having the ramp waveform differs for every power source line.

3. An image display device according to claim 1, wherein the power source line is provided for every display line and the power source line is formed of a plurality of power source lines which is divided into a plurality of groups, and a phase of the voltage having the ramp waveform differs for the power source lines of every group.

4. An image display device according to claim 1, wherein the voltage having the ramp waveform is a voltage which is changed at least one time from a first voltage level to a second voltage level having a potential higher than the first voltage level or from the second voltage level to the first voltage level during the light emitting period.

5. An image display device according to claim 1, wherein the voltage having the ramp waveform is a voltage whose voltage level is linearly changed with time.

6. An image display device according to claim 5, wherein the voltage having the ramp waveform is a triangular-wave voltage or a sawtooth-wave voltage.

7. An image display device according to claim 1, wherein the voltage having the ramp waveform is a voltage whose voltage level is non-linearly changed with time.

8. An image display device according to claim 1, wherein the write pixel selection means includes a plurality of scanning lines,
each pixel includes a drive transistor which has a first electrode thereof connected to the power source line and a second electrode thereof connected to one end of the light emitting element, a switching transistor which is connected between a gate electrode and the second electrode of the drive transistor, and a capacitive element which is connected between the gate electrode of the drive transistor and the corresponding signal line out of the plurality of signal lines, and another end of the light emitting element of each pixel is connected to a ground contact potential, and a gate electrode of the switching transistor is connected to the corresponding scanning line out of the plurality of scanning lines.

9. An image display device according to claim 8, wherein the drive transistor and the switching transistor are formed of a p-type transistor.

10. An image display device according to claim 8, wherein the drive transistor and the switching transistor respectively have a semiconductor layer which is made of amorphous silicon.

11. An image display device according to claim 8, wherein the drive transistor and the switching transistor respectively have a semiconductor layer which is made of polysilicon.

12. An image display device according to claim 8, wherein the switching transistor is configured to be turned on in a first period in which a reset voltage is supplied to the corresponding scanning line out of the plurality of scanning lines and to be turned off in other period during a writing period before the light emission period,
the image voltage is inputted to the pixel in which the switching transistor is turned off in the first period from the plurality of signal lines in the first period and in the second period which succeeds the first period during the writing period, and
a voltage having a high potential is inputted to the pixel in which the switching transistor is turned off in the first period from the power source lines in the first period and in the second period.

13. An image display device according to claim 1, wherein the light emitting element is an organic light emitting diode element.
